(19) United States
(12) Patent Application Publication
(10) Pub. No.: US 2015/0102040 A1
(43) Pub. Date: Apr. 16, 2015

(54) MOUNTING DEVICE FOR MOUNTING A FLEXIBLE TANK INSIDE A COMPARTMENT

(71) Applicant: AIRBUS HELICOPTERS, Marignane (FR)

(72) Inventor: Sylvain BORNES, Coudoux (FR)

(21) Appl. No.: 14/503,731

(22) Filed: Oct. 1, 2014

(30) Foreign Application Priority Data
Oct. 11, 2013 (FR) 13 02368

(51) Int. Cl. B64D 37/04

(52) U.S. Cl. CPC B64D 37/04
USPC 220/562

(57) ABSTRACT

A mounting device (10c) for mounting a flexible tank (1c) inside a compartment (2c), said fastening device (10c) comprising: a plurality of first fastening elements (11, 11′) secured to said flexible tank (1c), a plurality of second fastening elements (12) secured to said compartment (2c); and at least one cable (13a, 13b). Each cable (13a, 13b) passes through first fastening elements (11, 11′) and through second fastening elements (12) to shape and to mount said flexible tank (1c) inside said compartment (2c). Said mounting device (10c) further comprises at least one reversible tightening means (15a, 15b) for reversibly tightening said cable (13a, 13b), making it possible to tighten and to slacken said cable (13a, 13b).

### CROSS REFERENCE TO RELATED APPLICATION

This application claims priority to French patent application No. FR 13 02368 filed on Oct. 11, 2013, the disclosure of which is incorporated in its entirety by reference herein.

### BACKGROUND OF THE INVENTION

(1) Field of the Invention

The present invention relates to the field of fluid storage means, and in particular to installing such means.

The present invention relates to a mounting device for mounting a flexible tank inside a compartment, the mounting device being designed more particularly for a flexible fuel tank of a rotary-wing aircraft.

The present invention also relates to a fuel storage system using such a mounting device, and to a rotary-wing aircraft using such a fuel storage system.

(2) Description of Related Art

Aircraft, and in particular rotary-wing aircraft, have at least one and generally more than one fuel tank. Each tank is generally flexible and is housed in a respective compartment. Each such compartment can be situated in a lower structure of the aircraft, e.g. under the floor of the cabin of the aircraft, or else in vertical structures of the aircraft, such as transverse or lateral walls.

Each flexible tank, which is generally made of a material based on rubber, is firstly suitable for being installed inside a compartment that is generally larger than the opening with which said compartment is provided. In addition, the flexibility of the flexible tank makes it more resistant to impacts and/or to being shifted inside the compartment, and more particularly in the event of the aircraft crashing.

Generally, each tank is connected to the compartment by a lacing system. Such a lacing system is constituted by a cord, e.g. made of nylon, that interconnects rings that are present on the tank and rings that are present in the compartment.

Such a lacing system makes it possible to remove folds of skin that can appear while the tank is being put in place in the compartment. Such a lacing system also avoids any collapsing of the tank upon itself that might damage components inside the tank, such as a pump, a fuel level gauge, or a strainer. Such a lacing system thus makes it possible to guarantee the shape of the tank as soon as it is installed, and throughout the life of the aircraft.

In addition, if the aircraft crashes, at least some of the rings situated on the compartment and/or on the tank might open or indeed be separated from the compartment and/or from the tank, while the cord remains intact. The tank is then no longer fully connected to the compartment, and the tank can deform independently from the compartment, thereby avoiding any damage to or tearing of the tank.

However, such a lacing system is particularly cumbersome to put in place since the lacing is performed manually by an operator who must be inside the aircraft.

After inserting the tank into the compartment, the operator must put the cord that interconnects the tank and the compartment into place manually. For that purpose, the operator firstly has to cut an appropriate length of cord and burn the ends to prevent them from fraying, since the cord is generally made of nylon.

Then, the operator needs to thread the cord through each ring secured to the tank and through each ring secured to the compartment, since the rings are closed. Finally, the operator needs to tension the cord manually and tie a predefined knot at each end of the cord, thereby fastening it to a ring.

In addition, the cord can generally be put into place on the upper portion of the tank only, the lower portion being too difficult of access for such manual operations to be performed once the tank is in place inside the compartment. As a result, the extent to which the tank can be adjusted to fit the compartment is limited, since the skin of the tank can be tensioned in its upper portion only.

In addition, it is important or indeed essential to put the tank in place properly at the bottom of the compartment so as to make it possible to interconnect two tanks reliably via a specific pipe. The operator must then perform manually the operation of putting the tank in place properly.

In addition, not having any folds in the skin of the tank at the bottom of the compartment or on any other face of the tank reduces the risks of the skin of the tank being degraded over time.

The effectiveness of such shaping of the tank can then vary, since the cord holding the tank inside the compartment is tensioned manually by the operator. The tank and the compartment are provided with numerous rings in order to compensate for the risk of tension of the cord being low while still achieving proper shaping of the tank inside the compartment.

Similarly, during maintenance operations, in order to remove the tank it is necessary to remove the cord before the flexible tank can be extracted from its compartment. Then, the same operation as mentioned above for putting the cord in place must be repeated once the flexible tank is installed in its compartment again.

This lacing operation is tedious and arduous for the operator, but it is essential and requires a considerable amount of time for installation and removal.

A flexible tank can also be suspended in its housing via rigid rods as described in Document US 2013/0214095. Those rods bear against partitions in that housing, and they are slid through sleeves that are secured to the top face of the tank. A flexible tank can also be suspended in its housing via energy-absorbing attachments as described in Document FR 2 763 313 or indeed by cables as described in Document FR 1 219 718.

Document US 2012/0272497 is also known that describes a system facilitating installation and removal of a flexible tank. Rollers are positioned inside the housing for the tank and in the vicinity of the opening in the housing, which rollers make it possible to install and to remove the tank. During that installation and removal, the tank rolls on the rollers, thereby facilitating inserting it into its housing and extracting it therefrom. Similarly, the presence of those rollers also avoids damaging the tank during the insertion and removal.

Finally, Document US 2010/0163680 describes a flexible tank containing a netting made of a thermoplastic material. While the tank is emptying and is gradually collapsing upon itself, that netting makes it possible to keep passageways in the tank for enabling the fluid to flow. That tank can therefore be emptied entirely of the fuel that it contains.

In addition, Documents BE 489 587, FR 962 459, and U.S. Pat. No. 2,519,393 are part of the technological background.

### BRIEF SUMMARY OF THE INVENTION

An object of the present invention is thus to propose a mounting device for mounting a flexible tank inside a compartment that enables the above-mentioned limitations to be overcome. The mounting device should thus make it possible to simplify installing and removing the lacing system for lacing a flexible tank, thereby reducing the time required for those operations and their arduousness for an operator.

The mounting device should also make it possible to improve the shaping of the flexible tank, firstly by increasing the number of edges of the tank that are suitable for being provided with a lacing system, and secondly by facilitating tensioning of the lacing system.

Finally, the mounting device should make it possible to maintain the impact resistance and crash resistance properties of the flexible tank and should not have any major impact on the weight of the mounting device and on the weight of the flexible tank.

The invention provides a mounting device for mounting a flexible tank inside a compartment, which device comprises:

a plurality of first fastening elements suitable for being secured to the flexible tank;

a plurality of second fastening elements suitable for being secured to the compartment; and

at least one cable, each cable passing through at least some of the first fastening elements and through at least some of the second fastening elements to shape and to mount the tank inside said compartment.

This mounting device is remarkable in that it further comprises at least one tightening means for tightening each cable.

The mounting device is designed to mount each flexible tank inside a compartment of an aircraft, and more particularly of a rotary-wing aircraft. Like the lacing systems that are currently used in rotary-wing aircraft, this mounting device makes it possible, via at least one cable, to interconnect first fastening elements secured to a flexible tank and second fastening elements secured to a compartment in order to mount the flexible tank inside the compartment. Preferably, the cable passes in alternation through a first fastening element secured to the flexible tank and through a second fastening element secured to the compartment.

In addition, each cable is connected to tightening means in order to facilitate tightening each cable while the flexible tank is being put in place inside the compartment. These tightening means thus make it possible to tighten and to tension the cable, which, in particular, guarantees that the flexible tank is shaped and is put in place properly inside the compartment.

This mounting device may have a single cable or a plurality of cables, each cable preferably being connected to specific tightening means.

Using a single cable makes it possible to have a single tightening means and, as a result, a single operation for tightening the cable for the purpose of shaping the flexible tank inside the compartment. Said cable may be positioned on a single face of the flexible tank, thereby making it possible to tension only that face of the tank. Said cable may also be positioned on a plurality of faces of the flexible tank, thereby making it possible to tension those faces of the tank simultaneously. The mounting device having a single cable thus enables the flexible tank to be put in place quickly inside the compartment.

Conversely, a mounting device of the invention that has a plurality of cables and a plurality of tightening means is particularly well suited to a flexible tank that need to be put in place in a plurality of distinct steps, e.g. when a plurality of flexible tanks are to be interconnected. Such a mounting device of the invention that has a plurality of cables and a plurality of tightening means advantageously makes it possible to tension a plurality of faces of the flexible tank sequentially.

For example, the flexible tank is positioned in its compartment, and then a first cable positioned on the bottom face of said flexible tank is tensioned via first tightening means. This first operation makes it possible to remove the folds from said bottom face and then to interconnect at least two flexible tanks reliably via a specific pipe. Then, a second cable positioned on the top face of said flexible tank is tensioned via second tightening means in order to finish shaping the flexible tank inside the compartment.

Such a mounting device of the invention that has two distinct cables is thus particularly well suited to flexible tanks that are substantially rectangular block shaped. The two cables are preferably positioned on two opposite faces of said flexible tank.

In addition, the two tightening means may be positioned in a readily accessible zone of the flexible tank and on the same face of said tank.

In addition, such a mounting device advantageously makes it possible to tension a plurality of faces of said flexible tank independently from one another. This mounting device makes it possible to put in place and to shape flexible tanks that are of complex shapes, advantageously using all of the available volumes of the aircraft. The cables of the mounting device of the invention can then be positioned on a plurality of faces of said flexible tank of complex shape in order to enable it to be shaped inside the compartment.

Advantageously, each cable of said mounting device and each tightening means are preassembled to the flexible tank or to the compartment in such a manner as to facilitate shaping the flexible tank and putting it in place correctly inside the compartment.

In a first embodiment of the invention that is the preferred embodiment, each cable of said mounting device and each tightening means are preassembled to the flexible tank. To this end, the cable passes through the first fastening elements secured to the flexible tank. The first fastening elements are preferably secured to the edges of the flexible tank in order to enable the flexible tank to be shaped optimally.

Each first fastening element may be constituted by closed fastening means in order to prevent the cable from escaping from said first fastening element. The first fastening elements may, for example, be rings or indeed closed loops that are secured to the flexible tank. The first fastening elements may also be sleeves or indeed tubes that are secured to the flexible tank.

Using such sleeves or indeed such tubes makes it possible to distribute the tension of the cable linearly over the flexible tank unlike what is possible with a ring or a closed loop that applies the tension at a point. In addition, using such sleeves or indeed such tubes makes it possible to reduce the number of first fastening elements secured to the flexible tank and therefore to reduce the number of second fastening elements secured to the compartment. Using such sleeves or indeed such tubes also makes it possible to protect the cable from any external attack to which it might be subjected, in particular while it is being put in place in the compartment.

However, the length of such sleeves and of such tubes may be limited in order to preserve the flexibility of the tank that is necessary firstly for it to be put in place inside the compartment and secondly for it to resist impacts.

The first fastening means may comprise simultaneously both rings or closed loops and also sleeves or tubes, the sleeves or tubes being, for example, situated in the straight zones of the flexible tank and the rings or closed loops being situated in the curved zones and in the corners of the flexible tank.

In order to enable each cable to be fastened quickly to the compartment, the second fastening elements secured to the compartment are quick-fastening means. Since the cable is preassembled to the tank, it is not possible to thread the cable via one of its ends through the rings or the closed loops secured to the compartment. The quick-fastening means are formed by open loops, thereby making enabling the cable to be put in place in said second fastening elements. In addition, said quick-fastening means must also prevent the cable from being able to come out after the flexible tank has been put in place inside the compartment, i.e. without manual intervention from an operator, in order to make the mounting more secure. Finally, removing a tank, e.g. during a maintenance operation, is also facilitated by the presence of such quick-fastening means that make it easy and quick to separate the cable from the compartment.

These quick-fastening means are, for example, spiral in shape, thereby enabling the cable to be put in place quickly, said cable not being able to escape from the spiral without manual intervention from an operator.

The quick-fastening means may also be open loops, each provided with a moving closure system. The cable can thus be put in place easily in the quick-fastening means by moving aside the moving closure system, said moving closure system then preventing the cable from escaping from said quick-fastening means. Such quick-fastening means may, for example, be a snap clasp constituted by an open loop and by a metal blade provided with a resilient return system.

Naturally, the first fastening elements secured to the flexible tank may also be such quick-fastening means. Using such quick-fastening means makes it possible to facilitate mounting the cable on the flexible tank. Such use makes it possible, in particular, for the cable to be assembled to the tightening means prior to mounting the cable on the flexible tank. Similarly, using such quick-fastening means makes it possible to facilitate removing the cable from the flexible tank.

In a second embodiment of the invention, each cable of the mounting device and each tightening means are preassembled to the compartment. To this end, the cable passes through the second fastening elements secured to the compartment. Each second fastening element may be constituted by closed fastening means, such as a ring or indeed or closed loop, a sleeve, or indeed a tube in order to prevent the cable from being able to escape from said second fastening element. The second fastening elements secured to the compartment may also be constituted by quick-fastening means, e.g. spiral-shaped fastening means or indeed a snap clasp.

The first fastening elements secured to the flexible tank are then quick-fastening means for this second embodiment of the invention.

Each tightening means is connected to at least one cable and makes it possible to tension each cable and to maintain each cable under tension while the flexible tank is being used. Preferably, each tightening means is connected to a single cable, the mounting device of the invention having as many tightening means are there are cables.

Putting a tank in place inside its compartment is achieved more effectively and more quickly, since the manual operations are reduced and less arduous and tedious.

Advantageously, each tightening means is preferably reversible, i.e. it also enables the cable to be slackened without said cable being destroyed, thereby making it possible to re-use said cable and said tightening means.

Using such reversible tightening means also makes it possible to facilitate maintenance operations. Putting the tank back into place is made easier and quicker, since the cable remains intact and in place on the flexible tank or in the compartment.

For example, each tightening means may effect this tightening by winding the cable, the slackening being obtained by unwinding said cable. Winding the cable can be simple, i.e. effected via one end of the cable only, the other end being fastened to a stationary point of said tightening means or indeed to a fastening element. This winding of the cable may also be double, i.e. effected simultaneously via both ends of said cable.

Advantageously, such double winding makes it possible to tighten the cable and to slacken it twice as quickly as with single winding. In addition, such double winding makes it possible to distribute the tension better over the entire cable. Similarly, the friction stresses on the cable at each tightening means are also better distributed.

For example, each tightening means may comprise a rotary knurled knob and a winding spindle that are constrained in rotation with each other. The rotary knurled knob makes it possible, by being turned by an operator, to wind the cable around the winding spindle, slackening the cable being achieved by unwinding the cable from the winding spindle. These tightening means further comprise a locking system for locking the rotary knurled knob, preventing the cable from unwinding in untimely manner and, as a result, preventing the cable from losing tension.

The locking system may, for example, be constituted by a cog wheel secured to the knurled knob and by a stationary abutment in the tightening means, said stationary abutment allowing the knurled knob to move in rotation in a first direction only, corresponding to the cable being wound, and inhibiting movement in rotation in a second direction corresponding to the cable being unwound, without external intervention. Such tightening means may perform single winding or double winding of the cable.

The cable can be unwound via the rotary knurled knob, which is turned in the direction opposite to the winding direction by the operator, after acting on the locking system to release the rotary knurled knob in rotation.

Such unwinding of the cable may also be obtained by releasing the rotary knurled knob in rotation from the winding spindle, the winding spindle then being driven in rotation by the cable that relaxes. Conversely, the rotary knurled knob is constrained in rotation with the winding spindle firstly so as to enable the cable to be wound around the winding spindle, thereby tightening the cable, and secondly so as to maintain said cable under tension while the flexible tank is being used.

The rotary knurled knob may be released in rotation from the winding spindle by sliding relative to said winding spindle or indeed via a slidably mounted link piece.

Such reversible tightening means are used, in particular, for tightening footwear laces as described more precisely in Document U.S. Pat. No. 5,934,599.

Preferably, the cable is a metal cable of small cross-section in order to limit the volume of the tightening means. Since the cable is wound, for example, around the winding spindle, the larger the diameter of the cable, the larger the volume of winding of said cable. In addition, using a fine cable of small cross-section is favorable to effective tensioning of said cable, in particular at the corners of the tank.

For example, such a metal cable has a diameter lying in the range 0.5 millimeters (mm) to 1 mm.

However, the cable may be a non-metal cable, and, for example, be constituted by a thread or by a cord made of nylon.

Using this mounting device of the invention advantageously makes it possible to facilitate the operations of putting a flexible tank in place inside a compartment and the operations of maintaining said flexible tank. By means of the mounting device of the invention, such operations are made less arduous and less tedious to perform for the operator, and, in addition, they are also made quicker. In particular, tensioning the cable of the mounting device is achieved more effectively and repeatably. Finally, such operations can be integrated more effectively into an industrial process, since they are less subject to the uncertainties of manual operations performed by an operator.

In addition, this mounting device does not change the behavior of the flexible tank if the aircraft crashes, it being possible for the first and second fastening elements to open or to be separated respectively from the tank or from the compartment, while the cable and the tightening means remain intact.

The invention also provides a flexible fuel tank designed, in particular, for a rotary-wing aircraft. This flexible tank is provided with a mounting device as mentioned above, making it possible to mount and to shape said flexible tank inside a compartment of the aircraft.

The invention also provides a fuel storage system designed, in particular, for a rotary-wing aircraft. This fuel storage system comprises at least one flexible tank, at least one compartment, and a mounting device as described above for each flexible tank.

Each cable of a mounting device of said fuel storage device can thus be preassembled to the flexible tank or indeed to the compartment.

In addition, a compartment and a flexible tank of the fuel storage system may have a lower zone and an upper zone. A first cable of the mounting device then makes it possible to tension the flexible tank inside the compartment over the lower zone, and a second cable makes it possible to tension the flexible tank inside the compartment over the upper zone.

The invention also provides an aircraft including such a fuel storage system as described above, and more particularly a rotary-wing aircraft.

Such a rotary-wing aircraft may, for example, have a lower structure and a floor covering said lower structure, at least one compartment of the fuel storage system being situated in said lower structure.

A compartment of said fuel storage system may also be situated in a vertical structure of the aircraft, such as a transverse or a lateral partition.

### BRIEF DESCRIPTION OF THE SEVERAL VIEWS OF THE DRAWINGS

The invention and its advantages appear in greater detail from the following description of embodiments given by way of illustration with reference to the accompanying figures, in which:

FIG. 1 shows a rotary-wing aircraft equipped with a fuel storage system;

FIGS. 2 and 3 show a fuel storage system equipped with mounting devices for mounting each tank;

FIGS. 4 to 6 show three examples of closed fastening means;

FIGS. 7 and 8 show two examples of quick-fastening means; and

FIG. 9 shows a fragmentary view of an example of tightening means.

Elements that are present in more than one of the figures are given the same references in each of them.

### DETAILED DESCRIPTION OF THE INVENTION

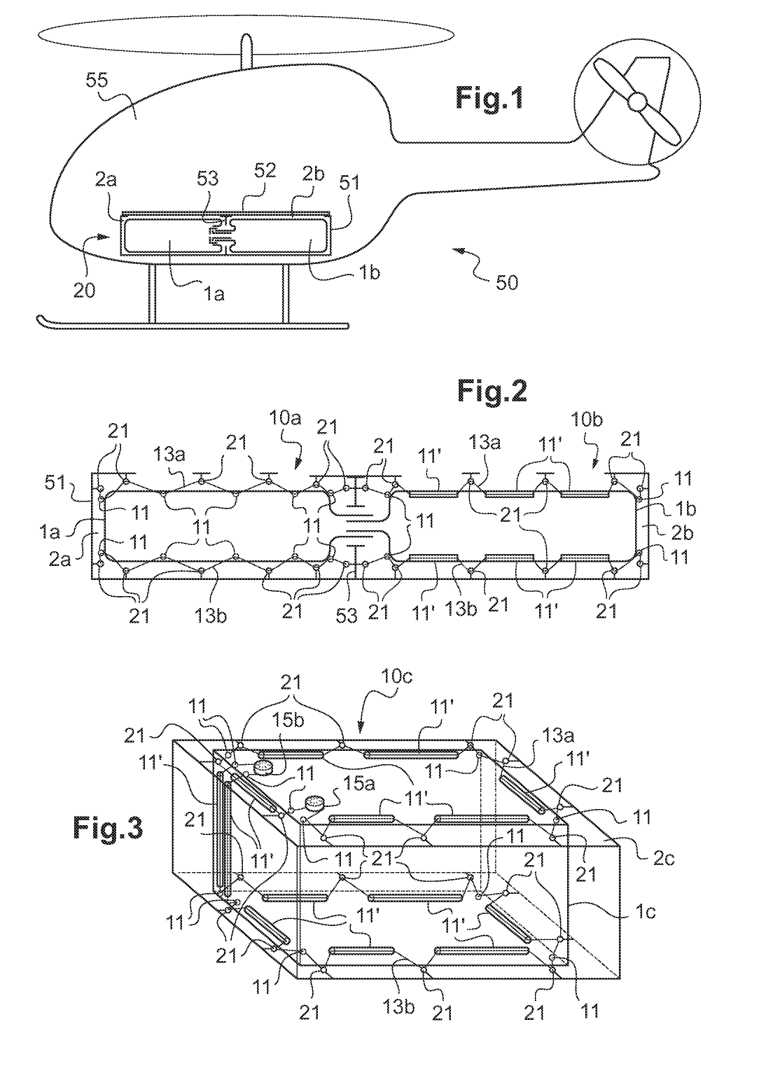

FIG. 1 shows an aircraft 50 including a lower structure 51 below a cabin 55, a floor 52 covering the lower structure 51, and a fuel storage system 20 situated inside the lower structure 51. This fuel storage system 20 comprises two compartments 2a, 2b separated by a structural partition 53 and two flexible tanks 1a, 1b disposed in respective ones of the compartments 2a, 2b.

In addition, a fuel storage system 20, comprising at least one compartment 2a, 2b and at least one flexible tank 1a, 1b, may also be situated in one or more vertical structures of the aircraft 50, such as transverse or lateral partitions.

FIG. 2 shows the fuel storage system 20 comprising two flexible tanks 1a, 1b that are substantially rectangular block shaped and that are situated in respective ones of the compartments 2a, 2b. Each flexible tank 1a, 1b is mounted and shaped inside its respective compartment 2a, 2b by a respective mounting device 10a, 10b.

Such a mounting device 10c of a flexible tank 1c mounted inside a compartment 2c is also shown in perspective in FIG. 3.

Each mounting device 10a, 10b, 10c comprises two cables 13a, 13b, first fastening elements 11, 11′, second fastening elements 12 and two tightening means 15a, 15b. These two tightening means 15a, 15b, shown in FIG. 3 only, are secured to the tank 1c, and more particularly to the top face of said tank 1c. These tightening means 15a, 15b are thus more accessible for an operator.

Each tightening means 15a, 15b thus makes it possible to tighten and to tension a cable 13a, 13b in order to shape the flexible tank 1a, 1b, 1c, and in order to mount it inside the compartment 2a, 2b, 2c. In addition, these tightening means 15a, 15b are reversible and also make it possible to slacken the cables 13a, 13b in order to make it possible, in particular, to remove the tank 1a, 1b, 1c.

The cables 13a, 13b are preassembled to the tank 1a, 1b, 1c, i.e. they have been assembled to the tank 1a, 1b, 1c before the flexible tank 1a, 1b, 1c is put in place in the compartment 2a, 2b, 2c. The cable 13a, 13b has thus been threaded through the first fastening elements 11, 11′ secured to the flexible tank 10a, 10b, and 10c.

The first fastening elements 11, 11′ are preferably secured to the edges of the flexible tank 1a, 1b, 1c in order to enable the flexible tank 1a, 1b, 1c to be shaped optimally inside the compartment 2a, 2b, 2c.

The first fastening elements 11, 11′ may be closed fastening means constituted firstly by rings 11 or by closed loops 11, and secondly by sleeves 11′ or by tubes 11′. The first fastening elements 11, 11′ are closed, i.e. an operator has threaded the end of the cable 13a, 13b through said first fastening elements 11, 11′. Advantageously, since these first fastening elements 11, 11′ are closed, the cable 13a, 13b cannot escape from said first fastening elements 11, 11′ once the two ends of said cable 13a, 13b are fastened, for example, to the tightening means 15a, 15b.

The use of sleeves 11′ or indeed tubes 11′ makes it possible to distribute the tension of the cable 13a, 13b linearly over the flexible tank 1a, 1b, 1c unlike what is possible with a ring 11 or a closed loop 11 that applies the tension at a point on the flexible tank 1a, 1b, 1c. The use of said sleeves 11′ or of said tubes 11′ also makes it possible to protect the cable 13a, 13b from any external attack to which it might be subjected, in particular while it is being put in place inside the compartment 2a, 2b, and 2c.

The first fastening elements 11, 11′ may simultaneously have rings 11 or closed loops 11, and also sleeves 11′ or tubes 11′, as shown in FIG. 3. The sleeves 11′ or tubes 11′ are preferably situated in the straight zones of the flexible tank 1c, and the rings 11 or the closed loops 11 are preferably situated in the corners of said flexible tank 1c and optionally in curved zones of said flexible tank 1c.

However, as shown in FIG. 2, a tank 1a may have only first fastening elements 11 constituted by rings 11 or by closed loops 11, while a tank 1b may have only first fastening elements 11′ constituted by sleeves 11′ or by tubes 11′.

Advantageously, the use of said sleeves 11′ or indeed said tubes 11′ makes it possible to reduce the number of first fastening elements 11, 11′ secured to the flexible tank 1a, 1b, and therefore to reduce the number of second fastening elements 12 secured to the compartment 2a, 2b.

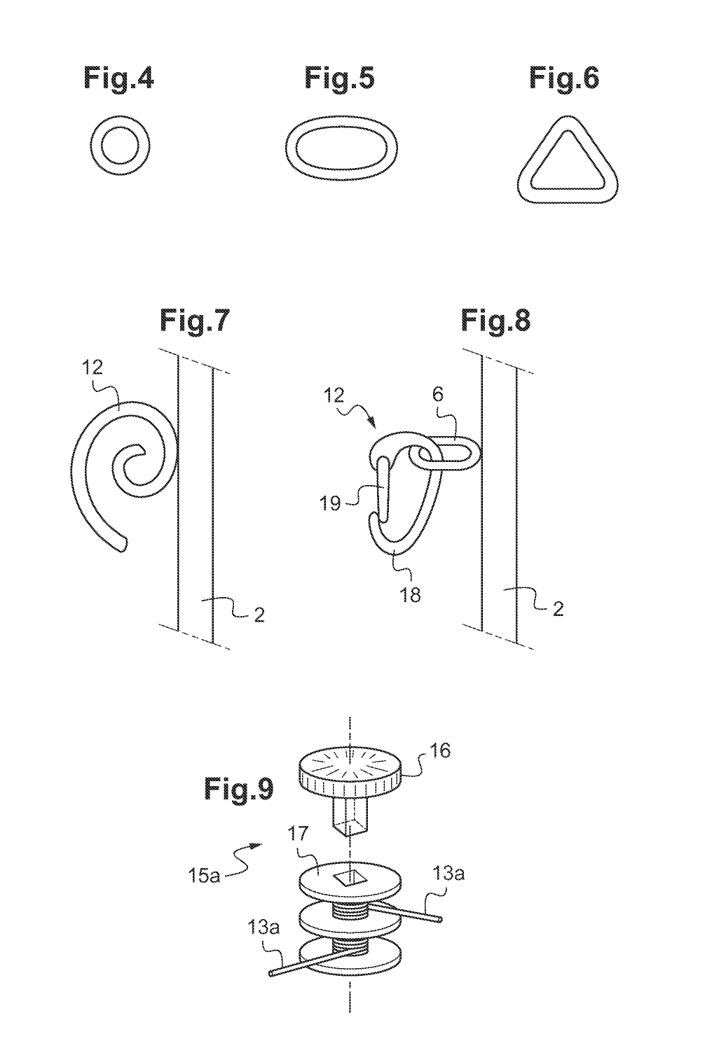

A ring 11 is shown in FIG. 4, and two examples of closed loops 11 that can take different forms are shown in FIGS. 5 and 6.

The second fastening elements 12 secured to the compartment 2a, 2b, and 2c are quick-fastening means formed by open loops. These quick-fastening means thus make it possible to put the cable 13a, 13b in place quickly in said second fastening element 12, while also preventing the cable 13a, 13b from being able to come out of said second fastening elements 12 after the flexible tank 1a, 1b, 1c has been put in place in the compartment 2a, 2b, 2c, i.e. without manual intervention from an operator, thereby making the mounting more secure.

The quick-fastening means also facilitate removing a flexible tank 1a, 1b, 1c during a maintenance operation, making it possible to separate the cable 13a, 13b quickly and easily from the compartment 2a, 2b, 2c.

The quick-fastening means may be open loops 12, e.g. spirally shaped loops as shown in FIG. 7. The cable 13a, 13b positioned in the center of this spirally shaped open loop 12 cannot escape from the open loop 12 without manual intervention from the operator.

The quick-fastening means may also be open loops 18 provided with a moving closure system 19 such as a snap clasp, as shown in FIG. 8. The cable 13a, 13b can thus be put in place easily in the quick-fastening means by moving aside the moving closure system 19, the moving closure system 19 then preventing the cable 13a, 13b from escaping from said quick-fastening means.

Said second fastening elements 12 may be secured directly to the compartment 2a, 2b, 2c as shown in FIG. 7, e.g. by welding. Said second fastening elements 12 may also be secured to the compartment 2 via a ring 6 as shown in FIG. 8, said ring 6, being, for example, secured to the compartment 2 by welding.

The two cables 13a, 13b are situated respectively on a bottom face and on a top face of the flexible tank 1a, 1b, 1c. A first cable 13b is positioned on the bottom face of said flexible tank 1a, 1b, 1c, and is tensioned via first tightening means 15b, while a second cable 13a is positioned on the top face of said flexible tank 1a, 1b, 1c, and is tensioned via second tightening means 15a.

Said first cable 13b makes it possible to tension only the bottom face of the flexible tank 1a, 1b, 1c, and, as a result, to remove any folds on said bottom face while the flexible tank 1a, 1b, 1c is being put in place inside the compartment 2a, 2b, 2c.

The second cable 13a makes it possible to tension the top face of the flexible tank 1a, 1b, 1c, and, as a result, to finish putting the flexible tank 1a, 1b, 1c in place and shaping it inside the compartment 2a, 2b, 2c.

The two tightening means 15a, 15b are situated on the top face of said flexible tank 1c in order to be accessible for an operator. The first cable 13b runs along a side face of the flexible tank 1a, 1b, 1c in order to reach the top face and in order to be connected to the first tightening means 15b. The first cable 13b runs through two sleeves 11′ on said side face in order to be protected from any external attack.

In addition, such a mounting device 10a, 10b, 10c may have more than two cables 13a, 13b in order to tension a plurality of faces of a flexible tank of complex form, and, as a result, in order to shape it.

Such a mounting device 10a, 10b, 10c may also have a single cable 13a, 13b in order to have only one tightening means 15a, 15b, and, as a result, only one tightening operation for tightening said cable 13a, 13b. Said cable 13a, 13b may be positioned on a single face of the flexible tank 1a, 1b, 1c, thereby making it possible to tension only that face of the tank 1a, 1b, 1c. Said cable 13a, 13b may also be positioned on a plurality of faces of the flexible tank 1a, 1b, 1c, thereby making it possible to tension those faces of the tank simultaneously, and, as a result, to put the flexible tank 1a, 1b, 1c in place quickly inside the compartment 2a, 2b, 2c.

An example of tightening means 15a enabling a cable 13a to be tightened and slackened is shown in fragmentary manner in FIG. 9. These tightening means 15a are reversible and include, in particular, a rotary knurled knob 16 and a winding spindle 17. The rotary knurled knob 16 makes it possible to drive the winding spindle 17 in rotation when it is turned by an operator. The winding spindle 17 then makes it possible to wind the two ends of the cable 13a simultaneously.

These tightening means 15a also include a locking system for locking the rotary knurled knob 16, preventing the cable 13a from unwinding in untimely manner and, as a result, preventing the cable 13a from losing tension, this locking system not being shown in FIG. 9.

The cable 13a can be unwound via the rotary knurled knob 16, which is turned in the direction opposite to the winding direction by the operator, after acting on the locking system to release the rotary knurled knob 16 in rotation.

The cable 13a can also be unwound by releasing the rotary knurled knob 16 from the winding spindle 17, e.g. by moving the rotary knurled knob 16 in translation. The winding spindle 17 is then driven in rotation by the cable 13a which relaxes.

The cable 13a, 13b is preferably a metal cable of small cross-section in order to limit its volume once it is wound around the winding spindle 17. For example, said metal cable has a diameter lying in the range 0.5 mm to 1 mm.

Naturally, the present invention may be subjected to numerous variants as to its implementation. For example, the first fastening elements 11 secured to the flexible tank 1a, 1b, 1c may be quick-fastening means. Using such quick-fastening means on the flexible tank 1a, 1b, 1c makes it possible to facilitate mounting and removing the cables 13a, 13b, and, in particular, enables each cable 13a, 13b to be assembled to the respective tightening means 15a, 15b prior to mounting the cable 13a, 13b on said flexible tank 1a, 1b, 1c.

In addition, the cables 13a, 13b may be preassembled to the compartment 2a, 2b, 2c instead of to the flexible tank 1a, 1b, 1c. In which case, the tightening means 15a, 15b are secured to the compartment 2a, 2b, and 2c. The first fastening elements 11 secured to the flexible tank 1a, 1b, 1c are then quick-fastening means. The second fastening means 12 secured to the compartment 2a, 2b, 2c may be closed fastening means or indeed quick-fastening means.

Although several embodiments are described, it should readily be understood that it is not conceivable to identify exhaustively all possible embodiments. It is naturally possible to envisage replacing any of the means described by equivalent means without going beyond the ambit of the present invention.

What is claimed is:

1. A mounting device for mounting a flexible tank inside a compartment, said mounting device comprising:
a plurality of first fastening elements suitable for being secured to said flexible tank;
a plurality of second fastening elements suitable for being secured to said compartment; and
at least one cable, each cable passing through at least some of said first fastening elements and through at least some of said second fastening elements to shape and to mount said flexible tank inside said compartment;
wherein said mounting device further comprises at least one tightening means for tightening each cable, each tightening means comprising a rotary knurled knob, a winding spindle and a locking system for locking said rotary knurled knob, said rotary knurled knob making it possible to wind said cable around said winding spindle, said locking system avoiding any untimely unwinding of said cable.

2. A mounting device according to claim 1, wherein said mounting device has two distinct cables and two distinct tightening means, each tightening means being connected to a single cable in order to tighten said cable.

3. A mounting device according to claim 1, wherein said tightening means are reversible, making it possible to slacken said cable, this slackening of said cable being performed by unwinding said cable from said winding spindle.

4. A mounting device according to claim 1, wherein said rotary knurled knob can be constrained in rotation or released in rotation with said winding spindle, said rotary knurled knob making it possible to tighten a cable by winding said cable around said winding spindle when said rotary knurled knob is constrained in rotation with said winding spindle, said cable being slackened by releasing said rotary knurled knob from said winding spindle and by unwinding said cable from said winding spindle.

5. A mounting device according to claim 1, wherein each first fastening element is constituted by quick-fastening means.

6. A mounting device according to claim 5, wherein at least one second fastening element is constituted by closed fastening means.

7. A mounting device according to claim 1, wherein each second fastening element is constituted by a quick-fastening system.

8. A mounting device according to claim 7, wherein at least one first fastening element is constituted by closed fastening means.

9. A flexible tank, wherein said flexible tank is provided with a mounting device according to claim 1, said mounting device making it possible to mount and to shape said flexible tank inside a compartment.

10. A flexible tank according to claim 9, wherein said first fastening elements are secured to edges of said flexible tank.

11. A fuel storage system comprising at least one flexible tank and at least one compartment, wherein said fuel storage system is provided with at least one mounting device according to claim 1, each mounting device making it possible to mount and to shape a flexible tank inside a compartment.

12. A fuel storage system according to claim 11, wherein, with at least one compartment and at least one flexible tank having a lower zone and an upper zone, said mounting device includes two cables, a first cable enabling said flexible tank to be tensioned inside said compartment over said lower zone, and a second cable enabling said flexible tank to be tensioned inside said compartment over said upper zone.

13. A fuel storage system according to claim 11, wherein at least one cable is preassembled to said flexible tank.

14. A fuel storage system according to claim 11, wherein at least one cable is preassembled to said compartment.

15. An aircraft, wherein said aircraft includes a fuel storage system according to claim 11.

16. An aircraft according to claim 15, wherein said aircraft includes a lower structure and a floor covering said lower structure, at least one compartment being situated in said lower structure.
